(19) United States
(12) Patent Application Publication
(10) Pub. No.: US 2024/0409021 A1
(43) Pub. Date: Dec. 12, 2024

(54) Suspended Tie Down Setup for Utility Vehicle Cargo Bays

(71) Applicant: Graeme John Astrauskas, Adelaide, South Australia (AU)

(72) Inventor: Graeme John Astrauskas, Adelaide, South Australia (AU)

(21) Appl. No.: 18/735,183

(22) Filed: Jun. 6, 2024

(30) Foreign Application Priority Data
Jun. 8, 2023 (AU) 2023901820

(51) Int. Cl. B60P 7/08

(52) U.S. Cl. CPC B60P 7/0815

(57) ABSTRACT

This invention is a suspended tie down setup for utility vehicle cargo bays. The setup consists of adjustable vertical tie down brackets that allows low height cargo to be contained, restrained and secured using tie down webbing straps. The setup also includes fixed horizontal rails. The brackets have multiple slots for tie down cam buckle straps and holes for ratchet tie down hooks. The bracket design allows multiple tie down straps and hooks to be used simultaneously and in any combinations and tensions, resulting in different low height cargo types, shapes and sizes being stacked and contained, restrained and independently secured by a suspended device. The rails are the platform for the brackets and are designed to provide full adjustability, versatility and functionality.

A mechanical suspended tie down setup for utility* vehicles that contains, restrains and secures low height cargo within a utility cargo bay. * Utility vehicles includes pickup vehicles and for all intents and purposes, are one and the same in this patent application.

### TECHNICAL FIELD OF INVENTION

The invention is a setup to tie down cargo using suspended vertical brackets to contain, restrain and secure various types, shapes and sizes of objects transported in utility vehicle cargo bays with a low height that otherwise may not be contained, restrained and secured with other setups. This setup maximises and minimises the amount of cargo that can be placed in a cargo bay and tied down due to its suspended form, adjustability, versatility and functionality, as it is not restricted by the limitations of others setups.

### BACKGROUND OF INVENTION

The typical setup for tying down cargo in utility vehicle cargo bays is a rail and cleat assembly fitted to the upper inner side sections of utility cargo bays. This setup is limited to securing cargo with a height higher than the rail and cleat assembly, as it is not possible to tie down low height cargo with a height that is below the rails and cleats using tie down straps and hooks.

Experience with the rail and cleat setup and its limitations and inadequacies, resulted in both large and small objects such as hard military cargo boxes, travel bags and cases, tool boxes, power tool cases, food crates, ice coolers, fishing tackle boxes and bags etc., moving around the entire utility vehicle's cargo bay while driving. Low height freight cartons, cardboard boxes and stacked timber planks, sheets and shelves were also subject to movement.

Movement of cargo that is not properly contained, restrained and secured is potentially at risk of damaging not only the vehicle cargo bay and the cargo, but also other vehicles and objects and injuring people while in transit. In particular, in the event of hard braking and acceleration, cornering, sudden stops and impacts.

To solve the issues and problems of low height cargo movement in utility vehicle cargo bays and increase road safety in that respect, the invention addresses this situation by applying downward tension on cargo from a suspended setup. In addition, other advantages of the invention include but are not limited to:
Contains, restrains and secures cargo with both vertical and horizontal tensions.
Accommodates at least two tie down forms; straps and hooks with specific and separate anchor points for both.
Allows various cargo types, shapes and sizes to be stacked and independently tied down with different tensions.
Maximises the amount of cargo that can be placed in a cargo bay.
Ability to contain, restrain and secure multiple small objects anywhere in the cargo bay, including a singular small object. Thus, minimising cargo space.
Can secure low and high height cargo together and independently.
Multiple tie down anchor points for high above rail cargo that also facilitates different tie down tensions.

### SUMMARY OF INVENTION

### Product

The invention is called ASTRA™-Automotive Suspended Tiedown for Recreational Accessories and is a unique tie down setup for utility vehicles.

### Purpose—Concept Principles

ASTRA is a mechanical setup consisting of suspended vertical brackets, mounting plates and horizontal rails that contain, restrain and secure specifically below rail height cargo, but also above rail height cargo. Key component of the ASTRA setup is the Suspended Tiedown Bracket—STB™; the component that shifts the paradigm of typical rail and cleat tie down setups with its unique design that suspends the tie down anchor points and locks down cargo that is lower than the height of the rails!

### Details—Brackets and Mounting Plates

Suspended Tiedown Brackets (STB) have multiple slots for cam buckle type tie down straps and holes for ratchet type tie down hooks. STB design allows multiple tie down straps and hooks to be used simultaneously and in any combinations and tensions, resulting in different cargo types being stacked and independently tied down and secured below the height of the rails. Stacked cargo is independently restrained and secured and not reliant on the weight and pressure of the objects above to maintain tie down restraint and strength. STB's multiple slot and hole design facilitates multiple tie down anchor points that allows cargo to be restrained and secured at different vertical positions.

STB's dual and parallel hole design allows low height cargo to be contained, restrained and secured horizontally below rails and independent of vertical tie downs, by providing separate suspended horizontal tie down anchor points. As horizontal tie downs are tensioned, they work against each other; employing the dynamics and forces of push pull mechanics. Push pressure is applied to cargo from one horizontal tie down and cargo is forced against the pressure of the other horizontal tie down creating a pull effect and vice versa. The greater the tension the greater the effect. This unique independent horizontal tie down feature can be utilised without or with vertical tie downs. STB's parallel holes also provide multiple horizontal tie downs up cargo sides. STB's dual holes also facilitates multiple horizontal tie downs (back and front) by positioning cargo against cargo that is also vertically secured. Conventional rail and cleat tie down setups do not allow below rails low height cargo to be horizontally contained, restrained and secured in this way.

The assembly can be inverted at 180 degrees or re-positioned upwards to various heights and provide multiple tie down anchor points for high above rail cargo with different tie down tensions.

STB is fixed into position with a mounting plate that slides within the ASTRA rail providing full length cargo bay adjustability, maximising cargo bay space and is locked into position with two bolts. A short STB designed for above wheel arch positions locks into position with two bolts also. A heavier duty STB designed for increased strength and rigidity locks into position with four bolts and to a heavier duty rail.

A minimum of two STBs are required to tie down cargo, but multiple pairs of STBs can be used to accommodate varying cargo restraints and/or cargo transport requirements.

### Manufacture—Brackets and Mounting Plates

STB is manufactured from flat bar aluminium with computer numeric controlled (CNC) machined slots and holes. Mounting plates are manufactured from flat bar aluminium with CNC drilled and tapped holes. The heavier duty designs are manufactured in thicker gauge flat bar aluminium. Slots and holes can also be punched using a hydraulic punching machine as an alternate manufacturing method. STBs and mounting plates can also be manufactured in flat bar steel as a stronger and/or cheaper material option with machined or punched slots and holes.

### Details—Rails

ASTRA rails are an enclosed design with multi positioning sliding mounting plate slots and fixed mounting plate holes. The combination of sliding slots and fixed holes allows STBs to slide and position anywhere along the rails providing full adjustability; horizontally and vertically. This multi positioning for the STBs results in low height cargo being contained, restrained and secured anywhere in the cargo bay, without restrictions or limitations. Mounting plates slide horizontally within the rails and fix to each STB with bolts either along the slots and/or the fixed hole positions. When the bolts are tightened, pressure is applied to the rails and the mounting plates and the STBs clamp to the rails and lock into position. The rails fixed holes provide an additional locking mechanism, with the penetration of the bolts forming locking pins. Rail fixed holes can be utilised to tie down and secure above rail height cargo such as bikes using ratchet type tie down hooks and can be tied down below the rails using STBs and provide primary above rail and secondary below rail restraints and extra cargo stability by holding the lower section of cargo in position and preventing slippage. Alternatively, the STBs can be positioned slightly upwards and fixed to rail slots and/or holes to provide primary and secondary restraint utilising the STB holes in lieu of the rail fixed holes.

ASTRA is intended to be fitted to vehicle utility cargo bays as original equipment or aftermarket equipment. ASTRA rails are designed to be bolted to existing utility vehicle cargo bay rail fixing points. A single row of utility vehicle cargo bay rail fixing point bolt holes form part of the standard rail design. A heavier duty design has a duplicate row of rail bolt holes that provide a stronger mounting platform. The rail bolt holes align with vehicle cargo bay rail fixing point holes. The heavier duty design can also be bolted to a single row of cargo bay rail fixing points, but for maximum strength the cargo bay requires duplicate rows of fixing points per rail fitment that need to form part of a vehicle's design and manufacture.

### Manufacture—Rails

ASTRA rails are manufactured from square hollow tube aluminium with CNC machined slots and holes. The heavier duty design is manufactured in rectangular hollow tube aluminium. Slots and holes can also be punched using a hydraulic punching machine as an alternate manufacturing method. Rails can also be manufactured in steel tube as a stronger and/or cheaper material option with machined or punched slots and holes. Typical rails are extruded aluminium propriety designs in C channel type form. ASTRA rails are considered stronger due to increased torsional rigidity, resulting from the enclosed design, unlike typical extruded rails that are an open design.

### Conclusion

ASTRA has been manufactured as a prototype and testing has resulted in proof of concept and determined the setup is fit for purpose. The prototype has been used since 2021 and has proven effective in its present form.

### BRIEF DESCRIPTION OF DRAWINGS

ASTRA components, assemblies, installation and applications are described below and referenced to the figures that provide full details in the drawings.

FIG. 1—Components: Suspended Tiedown Bracket in standard and heavier duty designs, including a design variant, short standard and heavier duty designs for above vehicle wheel arch positions and mounting plates standard and heavier duty designs.

FIG. 2—Components: Rails standard and heavier duty designs outer side for vehicle installation and inner side for Suspended Tiedown Bracket installation, including mounting plates.

FIG. 3—Assembly: Rail standard design with Suspended Tiedown Brackets standard design installed.

FIG. 4—Assembly: Rail heavier duty design with Suspended Tiedown Brackets heavier duty design installed.

FIG. 5—Assembly: Suspended Tiedown Bracket standard design installed in an inverted position.

FIG. 6—Assembly: Suspended Tiedown Bracket heavier duty design installed in an inverted position.

FIG. 7—Components: Rail heavier duty plus design top side and bottom side for tie down options. Including outer side for vehicle installation and inner side for Suspended Tiedown Bracket installation, including mounting plates.

FIG. 8—Components: Standard design rails, Suspended Tiedown Brackets including short design for above vehicle wheel arch position, mounting plates and bolts.

FIG. 9—Assembly: Standard design rails, Suspended Tiedown Brackets including short design for above vehicle wheel arch positions, mounting plates and bolts installed.

FIG. 10—Installation: Standard design setup installed in vehicle cargo bay.

FIG. 11—Applications: Standard design setup with cargo tied down in vehicle cargo bay.

### DETAILED DESCRIPTION OF DRAWINGS

The invention drawings are illustrated in 2 dimensional form. Given tie down straps and hooks are universal products with basic operating procedures and functionality, tie down straps and hooks do not form part of the drawings. However, tie down straps and hooks are included in photographs to demonstrate the ASTRA setup and its applications.

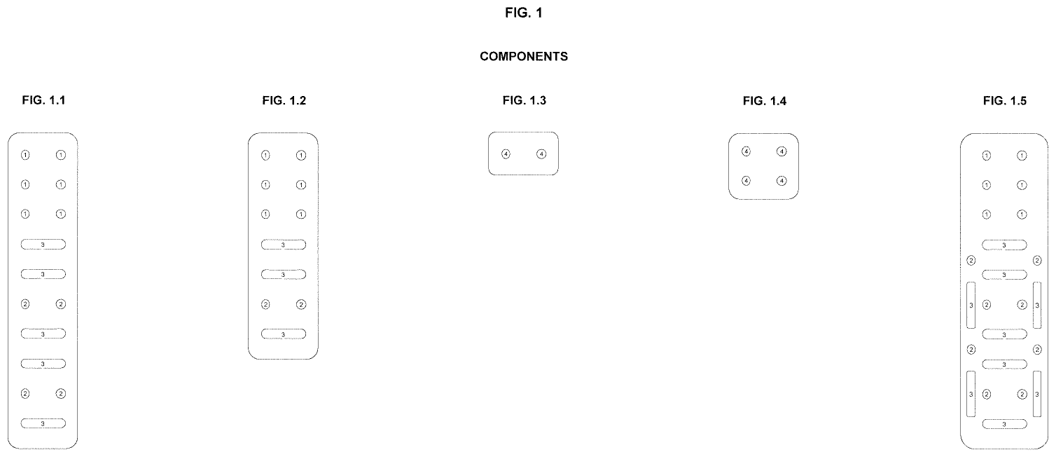

### FIG. 1 Page 1/16

FIG. 1.1 illustrates the Suspended Tiedown Bracket in both standard and heavier duty designs complete with mounting plate bolt holes (1), tie down hook holes (2) and tie down strap slots (3). The standard and heavier duty designs are manufactured in flat bar metal with the heavier duty design being thicker gauge. As the 2 dimensional illustration does not provide a depth perspective the gauge is not illustrated.

FIG. 1.2 illustrates the Suspended Tiedown Bracket short design for above vehicle wheel arch location in both standard and heavier duty designs with mounting plate bolt holes (1), tie down hook holes (2) and tie down strap slots (3). The standard and heavier duty designs are manufactured in flat bar metal with the heavier duty design being thicker gauge. A depth perspective is not illustrated to show the gauge.

FIG. 1.3 illustrates the mounting plate standard design with threaded mounting plate bolt holes (4). The mounting plate is manufactured in flat bar metal. A depth perspective is not illustrated to show the gauge.

FIG. 1.4 illustrates the mounting plate heavier duty design with threaded mounting plate bolt holes (4). The heavier duty design is a longer design to suit the heavier duty rail and is manufactured in thicker gauge flat bar metal. A depth perspective is not illustrated to show the gauge.

FIG. 1.5 illustrates a Suspended Tiedown Bracket design variant in both standard and heavier duty designs complete with mounting plate bolt holes (1), tie down hook holes (2) and tie down strap slots (3). This design variant shows additional tie down hook holes (2) and tie down strap slots (3) positioned on the outer edge of the Suspended Tiedown Bracket to facilitate independent horizontal tie downs. The standard and heavier duty designs are manufactured in flat bar metal with the heavier duty design being thicker gauge. A depth perspective is not illustrated to show the gauge.

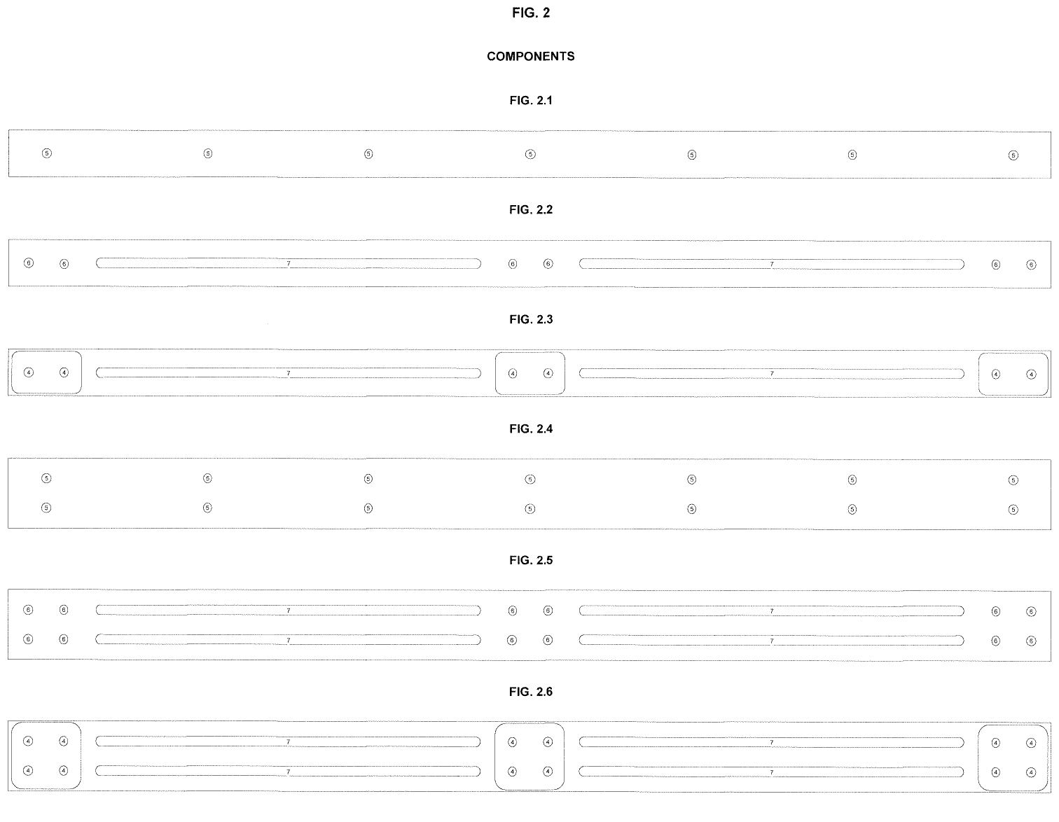

### FIG. 2 Page 2/16

FIG. 2.1 illustrates the rail standard design outer side for vehicle installation with the vehicle installation mounting holes (5). The standard rail design is manufactured in square hollow tube metal.

FIG. 2.2 illustrates the rail standard design inner side for Suspended Tiedown Bracket installation with the Suspended Tiedown Bracket fixed mounting plate holes (6) and the Suspended Tiedown Bracket multi positioning sliding mounting plate slots (7).

FIG. 2.3 illustrates the rail standard design inner side for Suspended Tiedown Bracket installation with the Suspended Tiedown Bracket standard design mounting plates in the fixed positions showing threaded mounting plate bolt holes (4) and the Suspended Tiedown Bracket multi positioning sliding mounting plate slots (7).

FIG. 2.4 illustrates the rail heavier duty design outer side for vehicle installation with the vehicle installation mounting holes (5). The heavier duty design includes a duplicate row of installation mounting holes. The heavier duty rail design is manufactured in rectangular hollow tube metal.

FIG. 2.5 illustrates the rail heavier duty design inner side for Suspended Tiedown Bracket installation with the Suspended Tiedown Bracket fixed mounting plate holes (6) and the Suspended Tiedown Bracket multi positioning sliding mounting plate slots (7). The heavier duty design includes a duplicate row of fixed mounting plate holes and sliding mounting plate slots that align with the Suspended Tiedown Bracket and mounting plate heavier duty designs.

FIG. 2.6 illustrates the rail heavier duty design inner side for Suspended Tiedown Bracket installation with the Suspended Tiedown Bracket heavier duty mounting plates in the fixed positions showing threaded mounting plate bolt holes (4) and the Suspended Tiedown Bracket multi positioning sliding mounting plate slots (7).

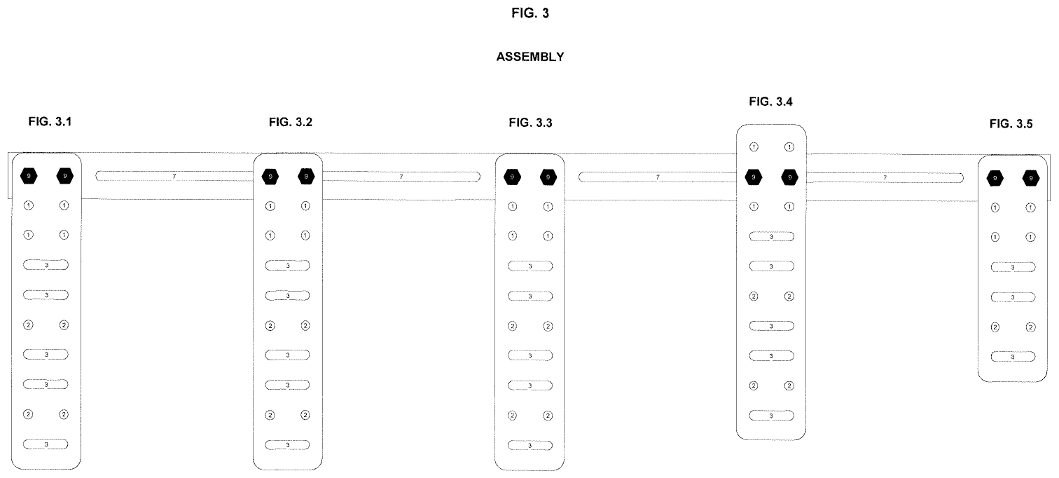

FIGS. 3,4,5 and 6 series of illustrations demonstrate the suspended form of the Suspended Tiedown Brackets when installed to the rail designs and depicts the below rail tie down anchor points (2) and (3) for containing, restraining and securing low height cargo below the rail height. This suspended form is the key principle of the ASTRA concept!

### FIG. 3 Page 3/16

FIG. 3.1 illustrates ASTRA components assembled with Suspended Tiedown Bracket standard design installed to the rail standard design. FIG. 3.1 shows STB bolted to the rear fixed mounting plate holes (9) and locked in position with the bolts penetrating through the mounting plate holes to form locking pins to provide an additional locking mechanism.

FIG. 3.2 illustrates ASTRA components assembled with Suspended Tiedown Bracket standard design installed to the rail standard design. FIG. 3.2 shows STB positioned against a multi positioning sliding mounting plate slot (7), bolted (9) and locked in position.

FIG. 3.3 illustrates ASTRA components assembled with Suspended Tiedown Bracket standard design installed to the rail standard design. FIG. 3.3 shows STB bolted to the centre fixed mounting plate holes (9) and locked in position with the bolts penetrating through the mounting plate holes to form locking pins to provide an additional locking mechanism.

FIG. 3.4 illustrates ASTRA components assembled with Suspended Tiedown Bracket standard design installed to the rail standard design and re-positioned above the rail to provide above rail height cargo restraint using mounting plate holes (1) as tie down anchor points. FIG. 3.4 shows STB positioned against a multi positioning sliding mounting plate slot (7), bolted (9) and locked in position.

FIG. 3.5 illustrates ASTRA components assembled with Suspended Tiedown Bracket standard short design installed to the rail standard design. FIG. 3.5 shows STB bolted to the front fixed mounting plate holes (9) and locked in position with the bolts penetrating through the mounting plate holes to form locking pins to provide an additional locking mechanism.

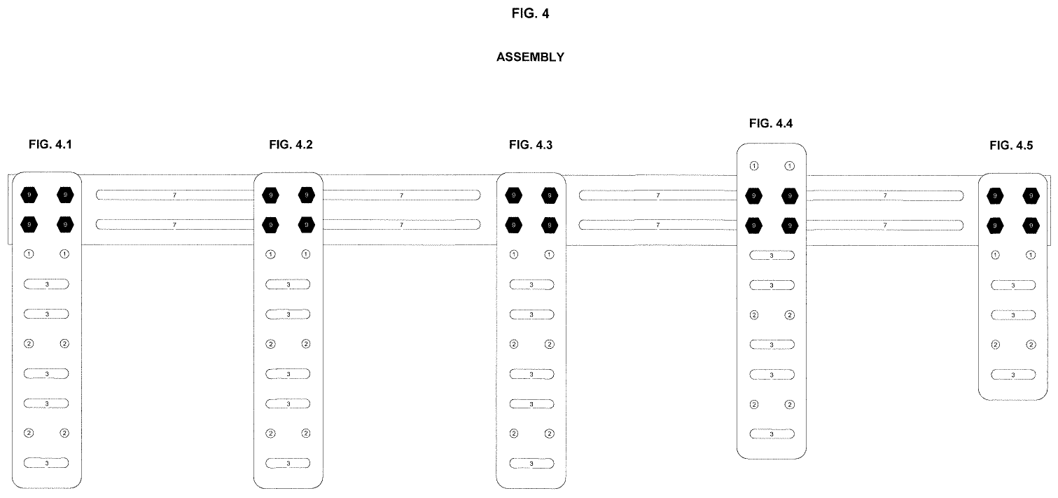

### FIG. 4 Page 4/16

FIG. 4.1 illustrates ASTRA components assembled with Suspended Tiedown Bracket heavier duty design installed to the rail heavier duty design. FIG. 4.1 shows STB bolted to the rear fixed mounting plate holes (9) and locked in position with the bolts penetrating through the mounting plate holes to form locking pins to provide an additional locking mechanism.

FIG. 4.2 illustrates ASTRA components assembled with Suspended Tiedown Bracket heavier duty design installed to the rail heavier duty design. FIG. 4.2 shows STB positioned against multi positioning sliding mounting plate slots (7), bolted (9) and locked in position.

FIG. 4.3 illustrates ASTRA components assembled with Suspended Tiedown Bracket heavier duty design installed to the rail heavier duty design. FIG. 4.3 shows STB bolted to the centre fixed mounting plate holes (9) and locked in position with the bolts penetrating through the mounting plate holes to form locking pins to provide an additional locking mechanism.

FIG. 4.4 illustrates ASTRA components assembled with Suspended Tiedown Bracket heavier duty design installed to the rail heavier duty design and re-positioned above the rail to provide above rail height cargo restraint using mounting plate holes (1) as tie down anchor points. FIG. 4.4 shows STB positioned against multi positioning sliding mounting plate slots (7), bolted (9) and locked in position.

FIG. 4.5 illustrates ASTRA components assembled with Suspended Tiedown Bracket heavier duty short design installed to the rail heavier duty design. FIG. 4.5 shows STB bolted to the front fixed mounting plate holes (9) and locked in position with the bolts penetrating through the mounting plate holes to form locking pins to provide an additional locking mechanism.

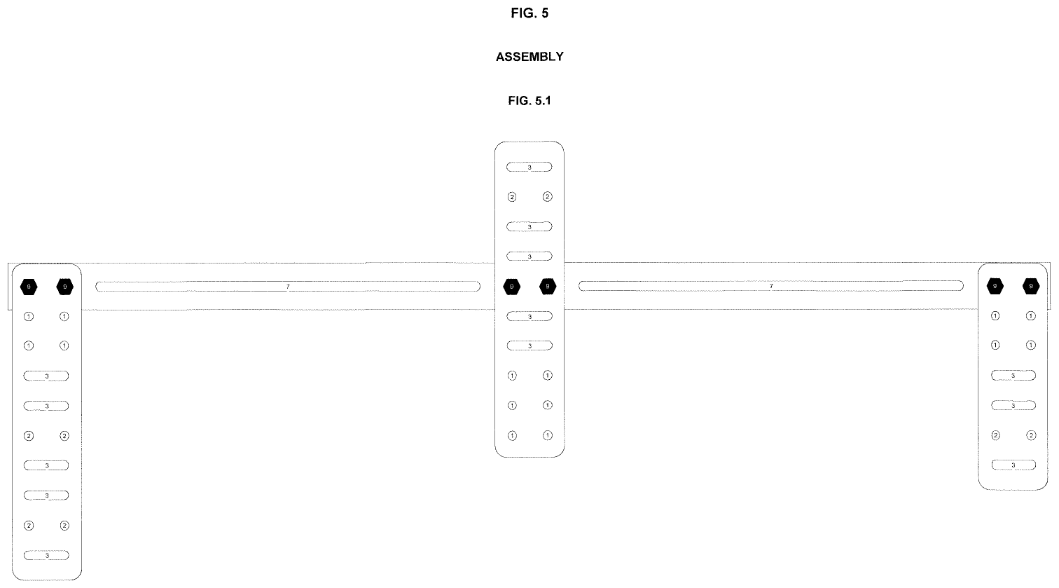

### FIG. 5 Page 5/16

FIG. 5.1 illustrates ASTRA components assembled with Suspended Tiedown Bracket standard design inverted 180 degrees and installed to the rail standard design. FIG. 5.1 shows STB bolted to the centre fixed mounting plate holes (9) and locked in position with the bolts penetrating through the mounting plate holes to form locking pins to provide an additional locking mechanism.

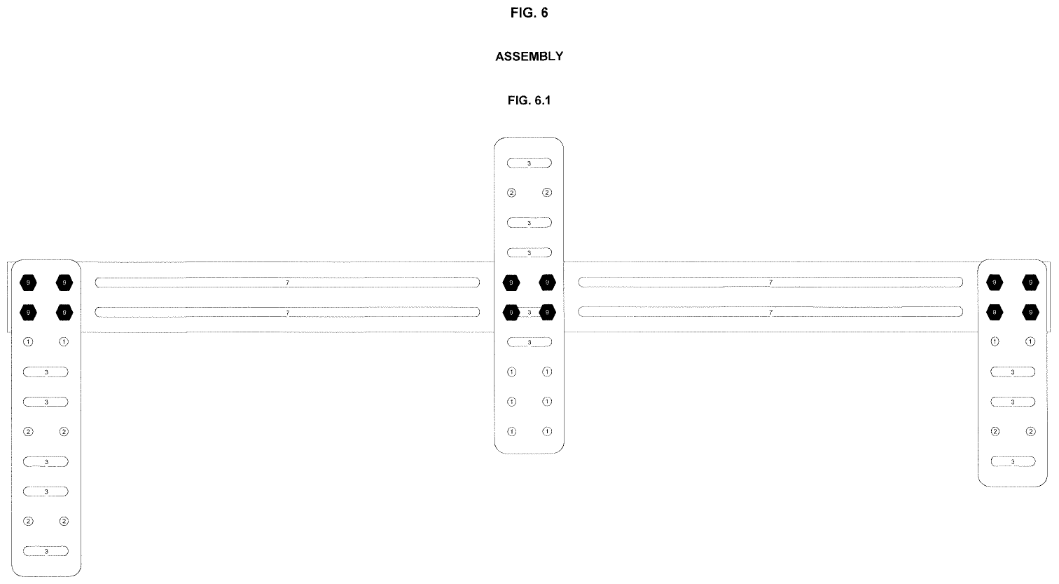

### FIG. 6 Page 6/16

FIG. 6.1 illustrates ASTRA components assembled with Suspended Tiedown Bracket heavier duty design inverted 180 degrees and installed to the rail heavier duty design. FIG. 6.1 shows STB bolted to the centre fixed mounting plate holes (9) and locked in position with the bolts penetrating through the mounting plate holes to form locking pins to provide an additional locking mechanism. FIG. 6.1 also shows STB bolted thought an STB tie down strap slot (3).

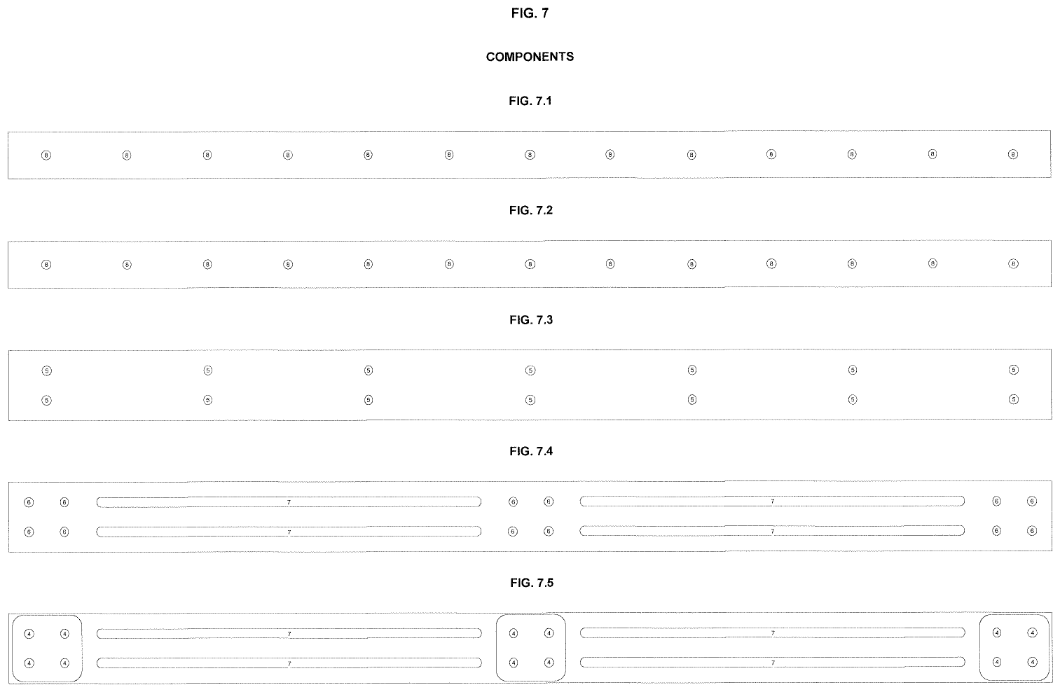

FIG. 7 series of illustrations demonstrate how the ASTRA rail designs can be adapted/modified for various tie down anchor point locations and types while accommodating installation of the Suspended Tiedown Brackets and associated features. This adaptive modified version is an example of how ASTRA, Suspended Tiedown Brackets and rail designs may be further developed and as such is to be included as part of this patent application, but at the same time is not to compromise the design merits of ASTRA, Suspended Tiedown Brackets, mounting plates and rail designs. The suspended concept principles and features of ASTRA, Suspended Tiedown Brackets, mounting plates and rail designs are inherent within the adaptive modified version described in FIG. 7.

### FIG. 7 Page 7/16

FIG. 7.1 illustrates the rail heavier duty plus design top side showing threaded holes (8) for tie down hooks, installation of lifting eye bolts, D shackles or threaded rods/bolts. The heavier duty plus rail design is manufactured in rectangular hollow tube metal.

FIG. 7.2 illustrates the rail heavier duty plus design bottom side showing threaded holes (8) for installation of lifting eye bolts or D shackles when/where these fittings cannot be installed in the top side threaded holes (8) due to the restrictions of a utility vehicle cargo bay hard lid and the limited clearance between the rails and lid. Top and bottom threaded holes (8) provide an alternative/stronger suspended tie down anchor option when a threaded rod/bolt is installed through the rail and swivel eye bolts are fitted; singular or multiple. Top and bottom threaded holes (8) can also be utilised for large D shackles. This design maybe applicable where a certified tie down rating is required.

FIG. 7.3 illustrates the rail heavier duty plus design outer side for vehicle installation with the vehicle installation mounting holes (5). The heavier duty plus design includes a duplicate row of installation mounting holes.

FIG. 7.4 illustrates the rail heavier duty plus design inner side for Suspended Tiedown Bracket installation with the Suspended Tiedown Bracket fixed mounting plate holes (6) and the Suspended Tiedown Bracket multi positioning sliding mounting plate slots (7). The heavier duty plus design includes a duplicate row of fixed mounting plate holes and sliding mounting plate slots that align with the Suspended Tiedown Bracket and mounting plate heavier duty designs.

FIG. 7.5 illustrates the rail heavier duty plus design inner side for Suspended Tiedown Bracket installation with the Suspended Tiedown Bracket heavier duty mounting plates in the fixed positions showing threaded mounting plate bolt holes (4) and the Suspended Tiedown Bracket multi positioning sliding mounting plate slots (7).

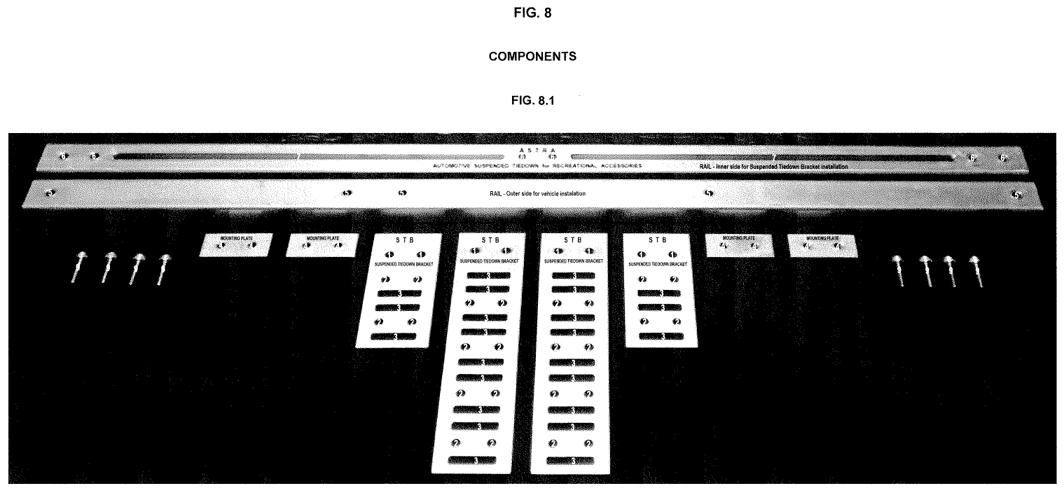

FIGS. 8, 9, 10 and 11 series of photographs show ASTRA standard design as a prototype demonstrating form and function and the design progression of ASTRA to a manufactured product.

### FIG. 8 Page 8/16

FIG. 8.1 displays standard design components of ASTRA:

Rail inner side for Suspended Tiedown Bracket installation with Suspended Tiedown Bracket fixed mounting plate holes (6) and Suspended Tiedown Bracket multi positioning sliding mounting plate slots (7). Rail outer side for vehicle installation with vehicle installation mounting holes (5). Rails are manufactured in square hollow tube metal.

Suspended Tiedown Brackets, including short design for above vehicle wheel arch positions complete with mounting plate bolt holes (1), tie down hook holes (2) and tie down strap slots (3). Suspended Tiedown Brackets are manufactured in flat bar metal.

Mounting plates complete with threaded mounting plate bolt holes (4).

Mounting plates are manufactured in flat bar metal.

Mounting plate bolts (9) are hex socket cap head stainless steel bolts.

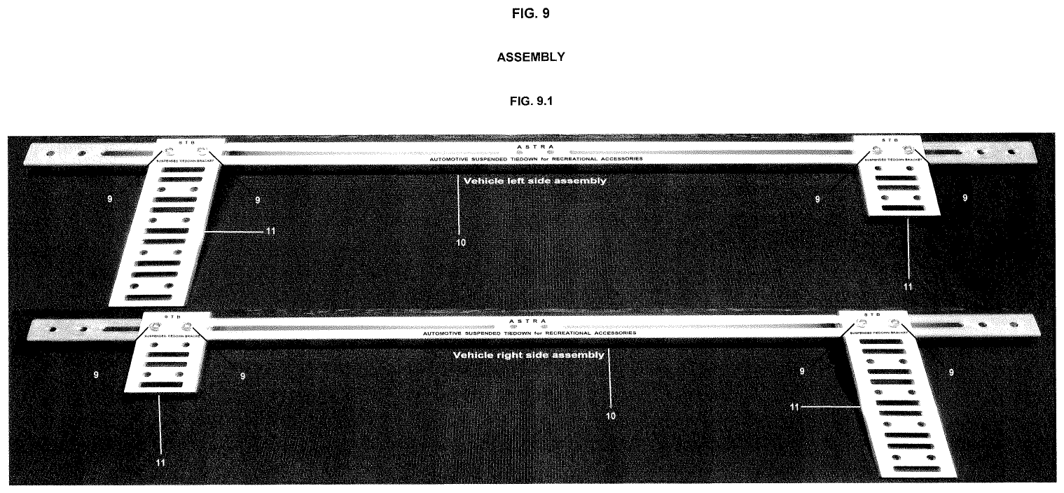

### FIG. 9 Page 9/16

FIG. 9.1 displays ASTRA standard design rails (10) and Suspended Tiedown Brackets (11) assembled and bolted (9) to concealed mounting plates.

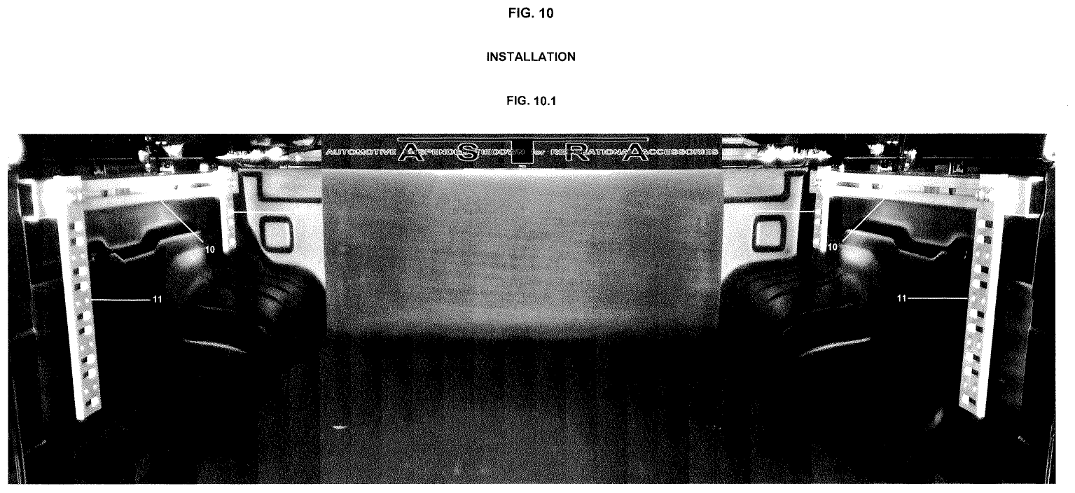

### FIG. 10 Page 10/16

FIG. 10.1 displays ASTRA standard design setup; rails (10) and Suspended Tiedown Brackets (11) installed in utility vehicle cargo bay.

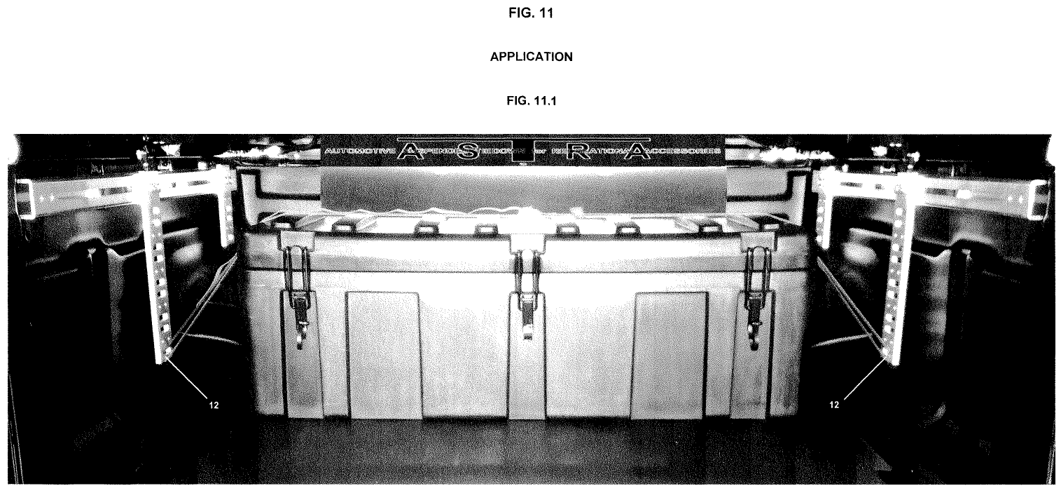

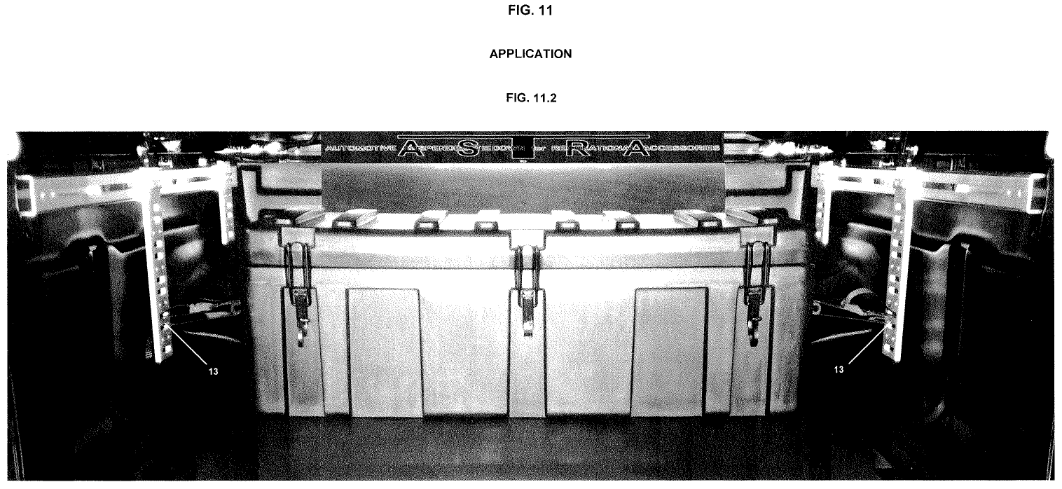

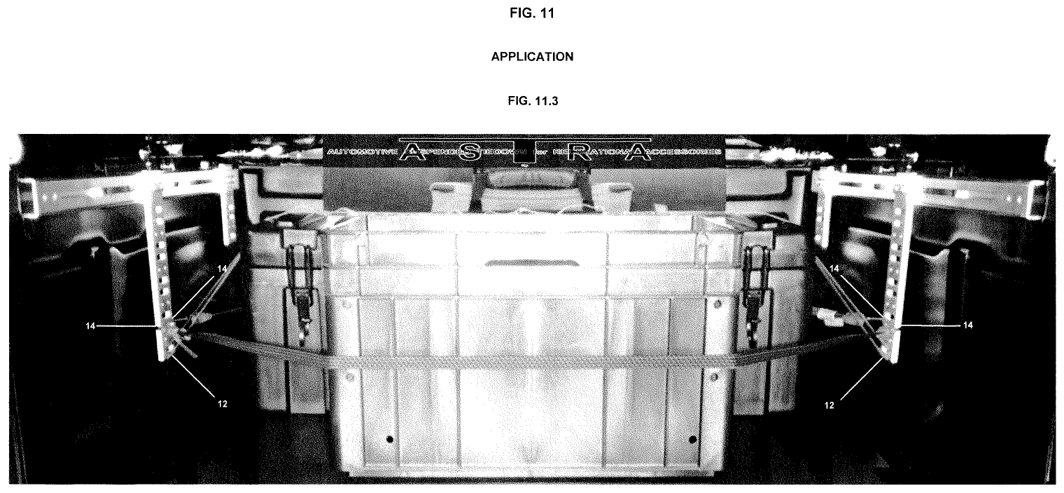

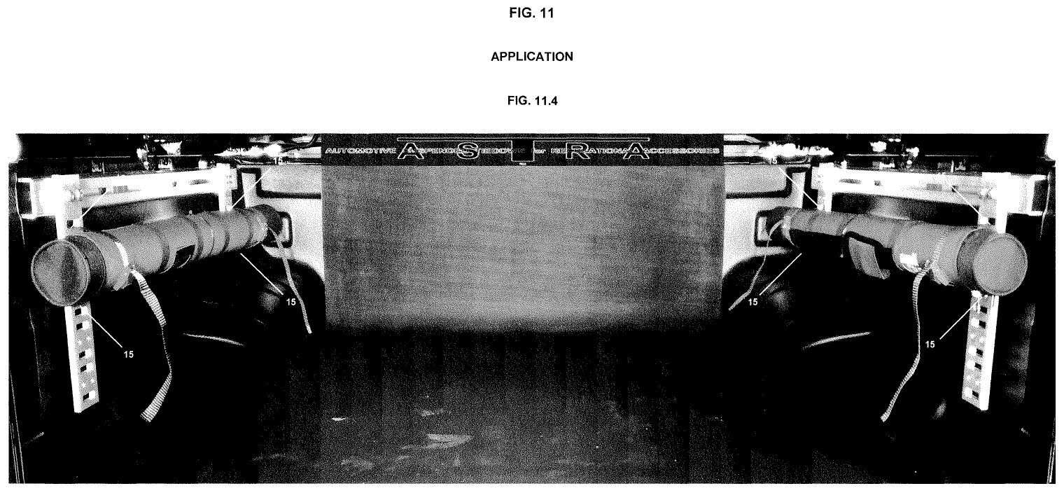

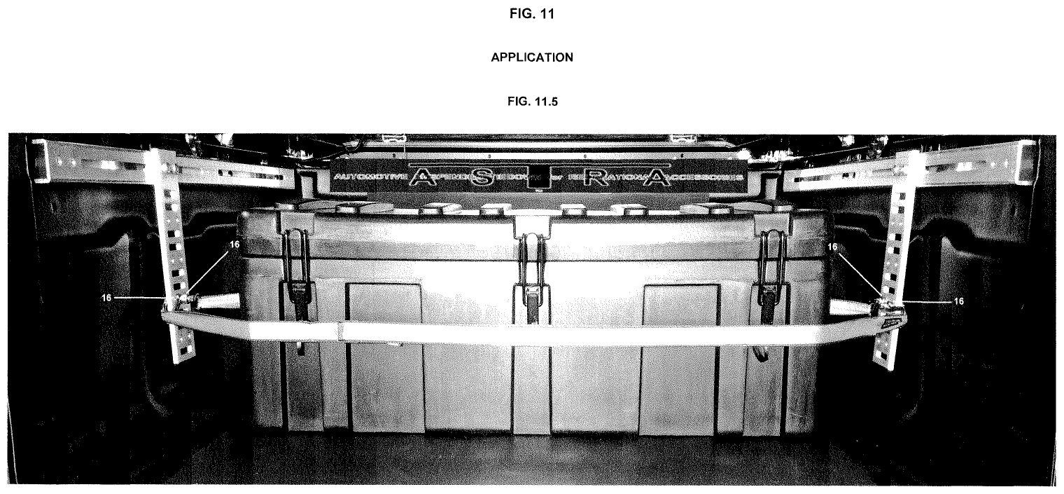

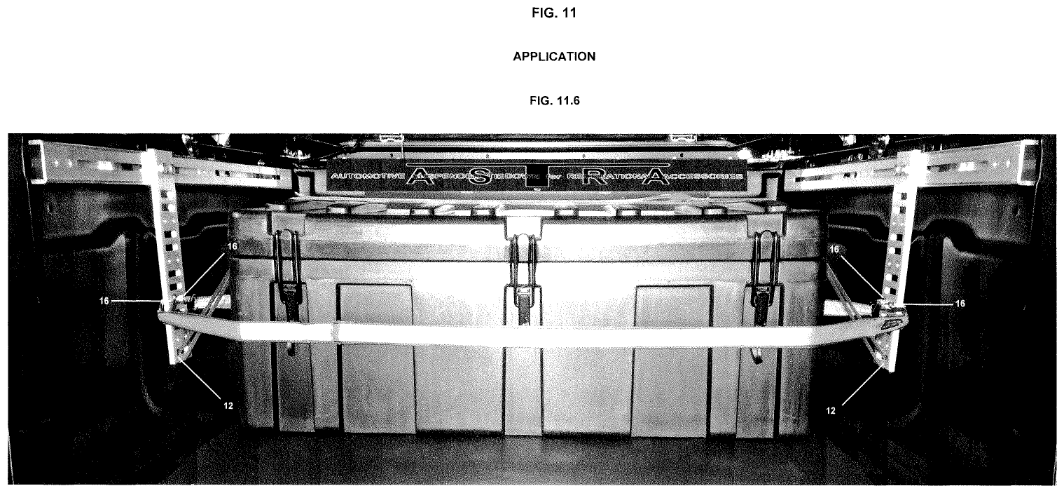

### FIG. 11 Page 11/16

FIG. 11.1 displays ASTRA standard design setup application securing low height cargo box below rails with suspended vertical tie downs (12).

### FIG. 11 Page 12/16

FIG. 11.2 displays ASTRA standard design setup application securing low height cargo box below rails with suspended horizontal tie downs (13).

### FIG. 11 Page 13/16

FIG. 11.3 displays ASTRA standard design setup application securing low height cargo box below rails with suspended vertical tie downs (12) and low height freight box and fishing tackle bag below rails with back and front independent suspended horizontal tie downs (14).

### FIG. 11 Page 14/16

FIG. 11.4 displays ASTRA standard design setup application securing tubular fishing rod holders horizontally with suspended horizontal tie downs (15).

### FIG. 11 Page 15/16

FIG. 11.5 displays ASTRA standard design setup application securing low height cargo box below rails with back and front independent suspended horizontal tie downs (16).

### FIG. 11 Page 16/16

FIG. 11.6 displays ASTRA standard design setup application securing low height cargo box below rails with back and front independent suspended horizontal tie downs (16) and suspended vertical tie downs (12).

Whereas it may be possible for derivatives, variations, modifications, redesigns etc. of ASTRA; a setup and design consisting of Suspended Tiedown Brackets, mounting plates, rails, associated designs, components and assemblies, to be developed by others with particular skills, the inherent suspended concept principles and features of ASTRA are integral to the ASTRA setup and design. Therefore, any and all derivatives, variations, modifications, redesigns etc. are considered to be constituent parts of ASTRA, as ASTRA described herein is not to be considered restricted or limited to the descriptions, illustrations, photographs, prototypes and examples thereof. All such derivatives, variations, modifications, redesigns etc. are considered to be developments reserved and limited to ASTRA, its Suspended Tiedown Brackets, mounting plates, rails, associated designs, components and assemblies.

1. Independent claim: A mechanical suspended tie down setup for utility/pickup vehicle cargo bays that contains, restrains and secures low height cargo below cargo bay internal rails from multiple independent suspended tie down anchor points/locations, vertically and horizontally with full adjustability and varying tensions while maintaining a central tie down strap alignment.

2. Dependent claim: The suspended tie down setup of claim 1 wherein the key component is a special suspended vertical bracket (special bracket) with multiple tie down anchor points and a mounting plate.

3. Dependent claim: The suspended tie down setup special bracket can be used to position various cargo types, shapes and sizes, as individual objects or multiple objects stacked and independently tied down with different tensions and minimise or maximise the amount of cargo that can be placed in a cargo bay below or above the internal rails.

4. Dependent claim: The suspended tie down setup special bracket can be used to tie down low height cargo below cargo bay internal rails horizontally using horizontal tensions and forces.

5. Dependent claim: The suspended tie down setup of claim 1 wherein a special horizontal internal rail (special rail) supports the special bracket as the platform from which the special bracket suspends.

6. Dependent claim: The suspended tie down setup special rail has holes in the top and bottom for alternate tie down options; locations and types.

7.Dependent claim: The suspended tie down setup special brackets and rails are made of flat bar and hollow tube metal respectively.
